(19) United States
(12) Patent Application Publication
(10) Pub. No.: US 2003/0085225 A1
(43) Pub. Date: May 8, 2003

(54) Cut-in box

(76) Inventor: Avdo Hodzic, San Jose, CA (US)

Correspondence Address: Kevin Roe, 4100 Moorpark Ave, Suite 225, San Jose, CA, 95117, US

(21) Appl. No.: 10/008,882

(22) Filed: Nov. 8, 2001

(51) Int. Cl. H02G 3/08

(52) U.S. Cl. 220/3.5

(57) ABSTRACT

An improved cut-in box and parts to facilitate the installation of a cut-in box and the safer connection of a cut-in box to at least one cable behind a wall. The improved cut-in box does not require the time-consuming use of a guide wire to route a flexible conduit behind a wallboard through a hole in the cut-in box during the installation process. A first embodiment of the invention involves an improved cut-in box to facilitate connection to at least one cable behind a wall. A second embodiment of the invention involves a cut-in box mounting bracket to clamp a cut-in box to a wall opening. A third embodiment of the invention involves an anti-short mechanism for an electrical cut-in box.

### BACKGROUND OF THE INVENTION

1. Field of the Invention

This invention relates generally to an improved cut-in box that can be more easily inserted through one side of a wall opening, and more particularly to an improved cut-in box with an improved mounting bracket and an anti-short mechanism that requires less installation labor and provides a more reliable connection to one or more cables on the opposite side of the wall opening.

2. Description of the Prior Art

Cut-in boxes, particularly electrical cut-in boxes, are present inside the walls of virtually every building. A cut-in box is typically a rectangular box enclosure of sheet metal in which an outlet or connector is connected to one or more cables routed through one or more holes in the enclosure. A cut-in box is typically installed through a rectangular wall opening formed in a sheet of wallboard (e.g., gypsum board, drywall, plywood, wood composite, or another equivalent) attached to a vertical wall stud (e.g. a piece of lumber or steel extending from the floor to the ceiling of a room). The wallboard thickness is typically greater than or equal to 0.625 inch (1.6 centimeters), depending on the application. A wall designed to act as a firewall typically has a considerably greater wallboard thickness than a wall designed to act merely as a partition between two rooms. Since vertical wall studs normally have wallboard vertically attached on both sides of the vertical wall studs to form room partitions, a cut-in box is normally designed to fit within the room partition (i.e., within the two sides of the vertical wall studs).

A large number of designs for conventional electrical cut-in boxes have been proposed, but the designs can be classified into a few groups. One group uses adjustable brackets and clamps to clamp the cut-in box to the back of a wall. A second group uses swivel “ears” to clamp the cut-in box to the back of a wall. A third group uses screw-in clamps that move forward to clamp the cut-in box to the back of a wall. A fourth group uses screws to pull pointed flanges forward to clamp the cut-in box to the back of a wall. A fifth group uses wallboard brackets and metal mounting brackets (e.g., strips of thin sheet metal stamped in an “F” shape with the two parallel straps of the “F” designed to fold around the edges of the conventional cut-in box) to clamp the cut-in box to the back of a wall.

Furthermore, conventional electrical cut-in boxes have taken various enclosure shapes in terms of the two dimensions of height and width in the plane of the wall (e.g., rectangular, square, octagonal, and circular), but the third dimension of depth (here depth is defined as the dimension that is perpendicular to the plane of the wall where the cut-in box is installed) has been almost completely linear in commercial implementation (i.e., the depth dimension is perpendicular to the height dimension and width dimension of the enclosure).

The conventional cut-in boxes and installation parts create some very significant practical problems. One problem is that the installation of a conventional cut-in box commonly requires the installer to bring out the cable(s) from behind the wall opening and route the cable(s) through a hole in one sidewall of the cut-in box enclosure, then push the cut-in box through the wall opening. However, since the cable(s) are now routed through the hole in the enclosure of the cut-in box, the rectangular shaped cut-in box cannot simply be pushed straight through the wall opening. Instead, the installer pushes the tilted cut-in box through the wall opening in a curving arc motion. Since the rectangular shaped cut-in box is tilted in a curved arc motion, the wall opening is normally significantly larger than the minimum cross-sectional area formed by the height and width dimensions of the cut-in box itself. For example, if the cable(s) are hanging down on the opposite side of the wall behind the wall opening (a common case), the cut-in box would normally be pushed through the wall opening in an upwardly curving arc motion, thus requiring that the height dimension of the wall opening be cut larger than the height dimension of the cut-in box.

Another problem is that the installer frequently has to weaken the wall by making a notch cut in the perimeter of the wall opening when the cable(s) (e.g., metal cables, armored cables, non-metallic cables, and other equivalents) are pulled out through the wall opening for the initial cable routing and connection. For example, in the most common case of a hanging cable, a notch cut would be made near the top of the perimeter of the wall opening. The notch cut would either penetrate the entire thickness of the wall, or significantly reduce the thickness of the wall perimeter behind the wall at the notch cut. The installer then installs and attaches labor-intensive mounting brackets to hold the cut-in box firmly against the perimeter of the wall around the wall opening.

An even worse problem than a notch cut in the wallboard around the wall opening is that some cable(s) cannot even normally be pulled out from behind the wallboard for connection to a conventional cut-in box, particularly if the cable(s) are enclosed in a large diameter metal conduit or flexible metal conduit when it is required by building codes, or if the wall is thicker than normal (e.g., it is a firewall or a wall constructed from a thick wallboard). In the case of a flexible metal conduit with a pre-installed threaded connector, the installer must insert a thick guide wire (e.g., a ceiling wire) through the hole of the cut-in box and hook it inside the flexible metal conduit. Then the installer must push the cut-in box into the wall and use the guide wire to pull the threaded connector on flexible metal conduit into alignment with the hole. Once the threaded connector is pulled inside the hole, the installer screws a locknut inside the cut-in box on the threaded connector to mechanically attach the flexible metal conduit to the cut-in box. Then the installer must retrieve the guide wire from the flexible metal conduit, which can be difficult. Typically, the use of a guide wire can account for half of the total labor time spent installing a conventional cut-in box. Therefore, the installation of a conventional cut-in box involves a large investment in labor time and labor cost, significantly limiting the number of conventional cut-in boxes that can be installed in a workday.

Another problem with the installation of a conventional cut-in box is the use of conventional mounting brackets (e.g., strips of thin sheet metal stamped in an “F” shape with the two parallel arms of the “F” designed to fold around the edges of the conventional cut-in box while clamping it against the wall). These conventional mounting brackets are also typically designed to have the very thin sheet metal edge push into the wall perimeter around the wall opening, frequently pushing too deep into the wallboard during or after installation, producing a wobbling motion in the cut-in box. During installation, these conventional mounting brackets also frequently fall into the cavity formed by two parallel sheets of wallboard attached to opposite sides of vertical wall studs, and are retrieved with great difficulty, especially when the vertical wall studs block side access to the cavity between the two walls. Thus, conventional mounting brackets require significant expensive labor time to clamp the conventional cut-in box to the wall.

Another problem is that the installation of a conventional cut-in box is so difficult and time-consuming that the installer will frequently route multiple electrical cables through one hole in one sidewall of the enclosure of the cut-in box. Building codes specify that multiple electrical cables are not supposed to be routed through the same hole in the cut-in box, since the electrical insulation of electrical cables ultimately get compressed and cut by the sharp edge of the sheet metal around the hole in the cut-in box, possibly creating a fire from an electrical short. Nonetheless, the installation of conventional cut-in boxes leads frustrated installers into making dangerous multiple cable routings, thus creating a safety problem.

Still another problem is that the installation of a conventional cut-in box commonly results in a considerable danger of an electrical short between an exposed wire segment of electrical cable(s) and the metal enclosure of the conventional cut-in box. This is an especially serious safety problem if the cut-in box is installed with a sheet metal mounting bracket that has arms that are bent over an exposed edge of the cut-in box. Electrical shorts are easily created between these bent arms on the inner surface of the cut-in box sidewall and the internal exposed conductors and cable(s) inside the cut-in box. Furthermore, since the connection of the cable(s) through the enclosure of the cut-in box normally precedes the actual installation and attachment of the cut-in box to the opposite side of the wall with conventional mounting brackets, a wobble in the cut-in box after installation in the wall opening with conventional mounting brackets can ultimately create a pulling force on the electrical cable(s) that can pull out an exposed wire segment. This wobbling motion and associated pulling force increase the probability of an eventual electrical short between the electrical cable(s) and the metal enclosure of the cut-in box, since an exposed wire segment of the electrical cable(s) is normally required for the connection(s) inside the cut-in box.

What is needed is an improved cut-in box which can be easily inserted through one side of a wall opening, more easily connected to one or more cables on the second side of the wall opening, and more reliably clamped to the perimeter of the wall opening. What is also needed is an improved mounting bracket that can be used with several types of cut-in boxes. What is also needed is an anti-short mechanism that can be used with several types of cut-in boxes.

### SUMMARY OF THE INVENTION

The present invention provides an improved cut-in box which can be easily inserted through one side of a wall opening, more easily connected to one or more cables on the second side of the wall opening, and more reliably clamped to the perimeter of the wall opening. The invention also provides an improved mounting bracket that can be used with several types of cut-in boxes. The invention also provides an anti-short mechanism that can be used with several types of cut-in boxes.

A first aspect of the invention is directed to an improved cut-in box to facilitate connection to at least one cable behind a wallboard. The improved cut-in box includes an enclosure with multiple sidewalls, having at least one sidewall curved in the depth dimension to facilitate insertion of the enclosure through a wallboard having a wall opening, wherein the enclosure has at least one sidewall with one or more entry points for connection to at least one cable behind the wallboard and the wall opening.

A second aspect of the invention is directed to a cut-in box mounting bracket to substantially clamp a cut-in box to a wall opening in a wallboard. The cut-in box mounting bracket includes a “U” shaped piece of material having a transverse member with a length having a first end and a second end, wherein a first arm is formed at the first end and a second arm is formed at the second end; and a piece of material formed in an “L” shape having a first leg and a second leg, and a width across the first leg and the second leg, wherein the width of the first leg of the “L” shape is substantially equal to the length of the transverse member of the “U” shaped piece of material, and the first leg of the “L” shape is designed to substantially conform to the wallboard in proximity to the wall opening.

A third aspect of the invention is directed to an anti-short mechanism for a sidewall of an electrical cut-in box. The anti-short mechanism includes an electrically insulating material having a substantially flat plane with an insulating first side and a second side; an adhesive layer deposited on the second side of the electrically insulating material; and a detachable substrate attached to the adhesive layer, wherein the electrical insulating material and the adhesive layer are easily removed from the substrate and easily attached to a sidewall of the electrical cut-in box.

These and other objects and advantages of the invention will become apparent to those skilled in the art from the following detailed description of the invention and the accompanying drawings.

### BRIEF DESCRIPTION OF THE DRAWINGS

FIG. 1A illustrates a side view of a conventional cut-in box being inserted through an opening in a wall.

FIG. 1B illustrates a perspective view of a conventional cut-in box with a cable routed into the conventional cut-in box, as it is inserted through an opening in a wall.

FIG. 1C illustrates a side view of a cut-in box according to one embodiment of the invention as it is inserted through an opening in a wall.

FIG. 1D illustrates a perspective view of a cut-in box according to one embodiment of the invention with a cable routed into the cut-in box, as it is inserted through an opening in a wall.

FIG. 2A illustrates a more detailed side view of a cut-in box according to one embodiment of the invention.

FIG. 2B illustrates a more detailed side view of the opposite side the cut-in box shown in FIG. 2A.

FIG. 2C illustrates a top view of the cut-in box shown in FIG. 2A.

FIG. 2D illustrates a bottom view of the cut-in box shown in FIG. 2A.

FIG. 3A illustrates a more detailed side view of a cut-in box according to another embodiment of the invention.

FIG. 3B illustrates a more detailed side view of a cut-in box according to another embodiment of the invention.

FIG. 4A illustrates a more detailed side view of a cut-in box according to another embodiment of the invention.

FIG. 4B illustrates a more detailed side view of a cut-in box according to another embodiment of the invention.

FIG. 5A illustrates a more detailed perspective view of a cut-in box shown in FIG. 4B.

FIG. 5B illustrates a more detailed front view looking into the cut-in box shown in FIG. 5A.

FIG. 5C illustrates a back view of the cut-in box shown in FIG. 5A.

FIG. 6A illustrates a more detailed perspective view of a cut-in box shown in FIG. 4A.

FIG. 6B illustrates a more detailed front view looking into the cut-in box shown in FIG. 6A.

FIG. 6C illustrates a back view of the cut-in box shown in FIG. 6A.

FIG. 7A illustrates a more detailed perspective view of a cut-in box according to another embodiment of the invention.

FIG. 7B illustrates a more detailed front view looking into the cut-in box shown in FIG. 7A.

FIG. 7C illustrates a back view of the cut-in box shown in FIG. 7A.

FIG. 8A illustrates a more detailed perspective view of a cut-in box according to another embodiment of the invention.

FIG. 8B illustrates a more detailed front view looking into the cut-in box shown in FIG. 8A.

FIG. 8C illustrates a back view of the cut-in box shown in FIG. 8A.

FIG. 9A illustrates a more detailed perspective view of a cut-in box according to another embodiment of the invention.

FIG. 9B illustrates a more detailed front view looking into the cut-in box shown in FIG. 9A.

FIG. 9C illustrates a back view of the cut-in box shown in FIG. 9A.

FIG. 10A illustrates a top view the two pieces of a mounting bracket according to one embodiment of the invention.

FIG. 10B illustrates a more detailed perspective view of a cut-in box according to another embodiment of the invention as it is installed in a wall.

FIG. 10C illustrates a more detailed top view of the cut-in box shown in FIG. 10B, including a top sidewall with a hole, the bent arm of one “U” shaped piece, with the “L” shape pressed up to the back of the wall.

FIG. 10D illustrates a perspective view of an anti-short mechanism, according to one embodiment of the invention.

FIG. 10E illustrates a more detailed perspective view of a cut-in box according to another embodiment of the invention as it is installed in a wall.

### DETAILED DESCRIPTION OF PREFERRED EMBODIMENTS OF THE INVENTION

The present invention provides an improved cut-in box, an improved mounting bracket that can be used with an improved cut-in box or several other types of cut-in boxes, and an anti-short mechanism to minimize electrical shorts between a metal cut-in box and one or more electrical cables. The present invention can also be applied to a cut-in box for one or more optical fiber cables to be optically routed through a wall opening. While the discussion below is directed to an application of the invention to secure one cut-in box to a wall opening, the invention can also be applied to a “gang” or “bank” of cut-in boxes mounted in adjacent proximity in a wall opening. The invention can also be applied to cut-in boxes installed in the walls of large containers or vehicles (e.g., automobiles, airplanes, ships, trains, and so forth), as well as cut-in boxes installed in the walls of buildings.

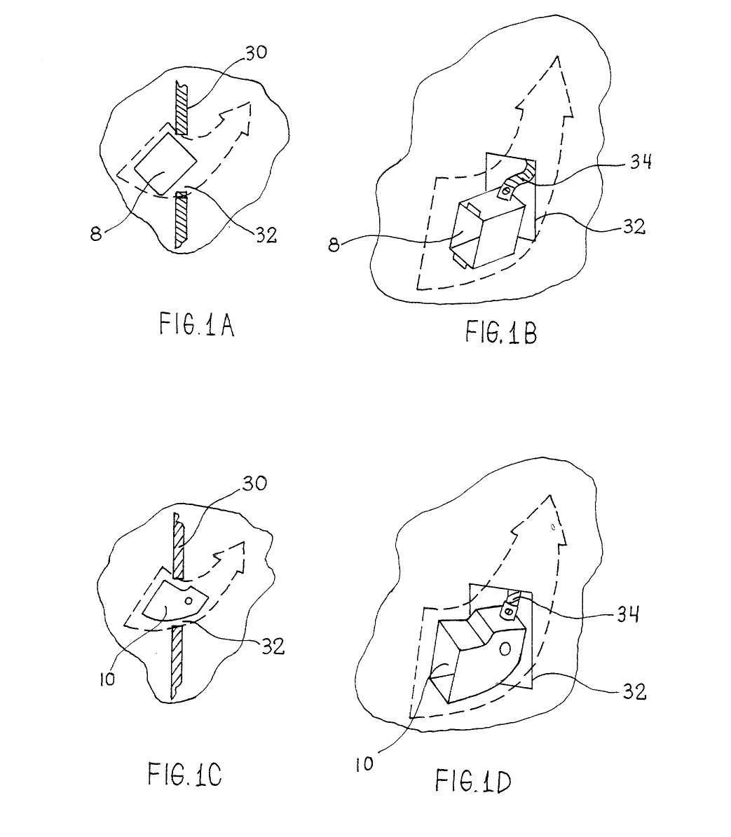

FIG. 1A illustrates a side view of a conventional cut-in box 8 being inserted through an opening 32 in a wall 30.

FIG. 1B illustrates a perspective view of a conventional cut-in box 8 with a cable 34 routed into the conventional cut-in box 8, inserted through an opening 32 in a wall 30.

FIG. 1C illustrates a side view of a cut-in box 10 according to one embodiment of the invention as it is inserted through an opening 32 in a wall 30.

FIG. 1D illustrates a perspective view of a cut-in box 10 according to one embodiment of the invention with a cable 34 routed into the cut-in box 10, inserted through an opening 32 in a wall 30.

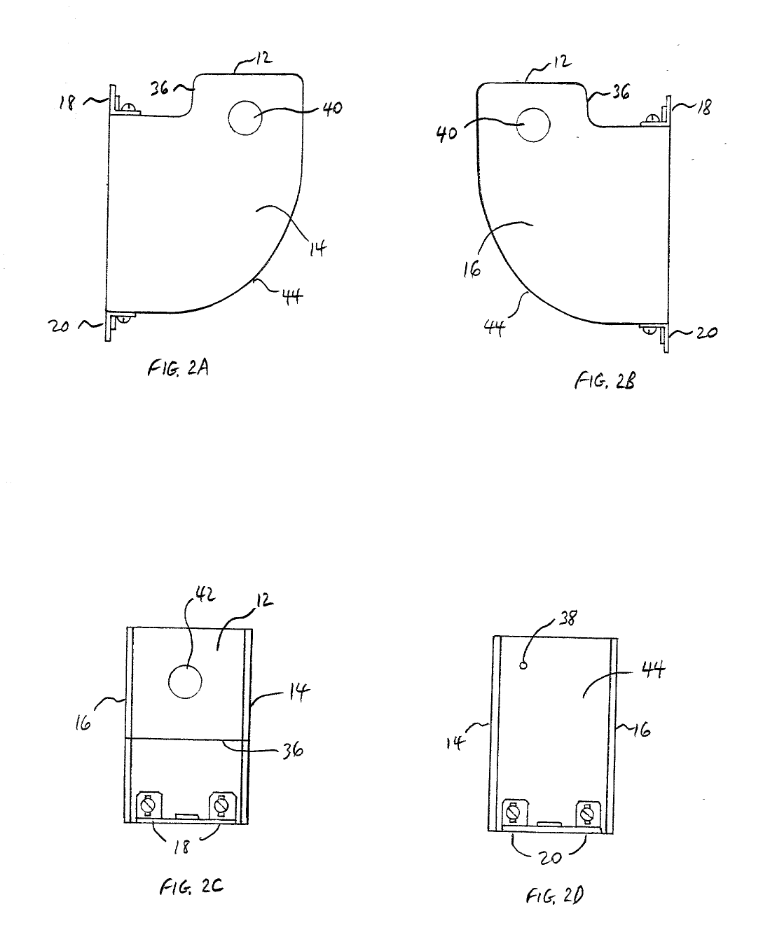

FIG. 2A illustrates a more detailed side view of a cut-in box according to one embodiment of the invention. The cut-in box has a “J” curved sidewall 44, a top sidewall 12 with a neck 36, a sidewall 14 with an entry point (e.g., hole or knockout) 40 in which to route a cable (not shown), and edge brackets 18 and 20. The distance between the neck 36 and the edge bracket 18 would normally be greater than or equal to the thickness of the wall (not shown).

Embodiments of the invention that include a neck 36 provide many advantages over conventional cut-in boxes. The neck 36 can allow an installer to connect cable(s) through the top of the neck 36 without actually completely inserting the cut-in box through the wall opening, if the neck has enough extension. The neck 36 also provides additional protection and additional mechanical support to a cable connection through the neck 36. The neck 36 provides additional volume inside the cut-in box for cable connections inside the cut-in box. This extra volume compensates for the cut-in box volume lost from curving a sidewall, as compared to a conventional rectangular cut-in box. In embodiments in which the distance between the neck 36 and the edge bracket 18 is close to the thickness of the wall, the wobble of the cut-in box can be reduced by a snug fit between the neck 36 and the wall, thus decreasing the likelihood that a wobbling cut-in box will induce pulling forces on the electrical cable(s) that will gradually pull out an exposed electrical wire to create an electrical short to the cut-in box.

FIG. 2B illustrates a more detailed side view of the opposite side the cut-in box shown in FIG. 2A. The cut-in box has a curved sidewall 44, a top sidewall 12 with a neck 36, a sidewall 16 with an entry point 40 in which to route a cable (not shown), and edge brackets 18 and 20, which are not required in all embodiments of the invention. Various embodiments can have edge brackets 18 and 20 attached to the cut-in box by various means (e.g., welding, soldering, adhesives, screws, or some other equivalent attachment process).

FIG. 2C illustrates a top view of the cut-in box shown in FIG. 2A. The cut-in box has sidewalls 14 and 16, an entry point 42 in the top sidewall 12 with a neck 36, and edge bracket 18.

FIG. 2D illustrates a bottom view of the cut-in box 10 shown in FIG. 2A. The cut-in box has sidewalls 14 and 16, a sidewall 44 with a hole 38 for a ground screw (not shown).

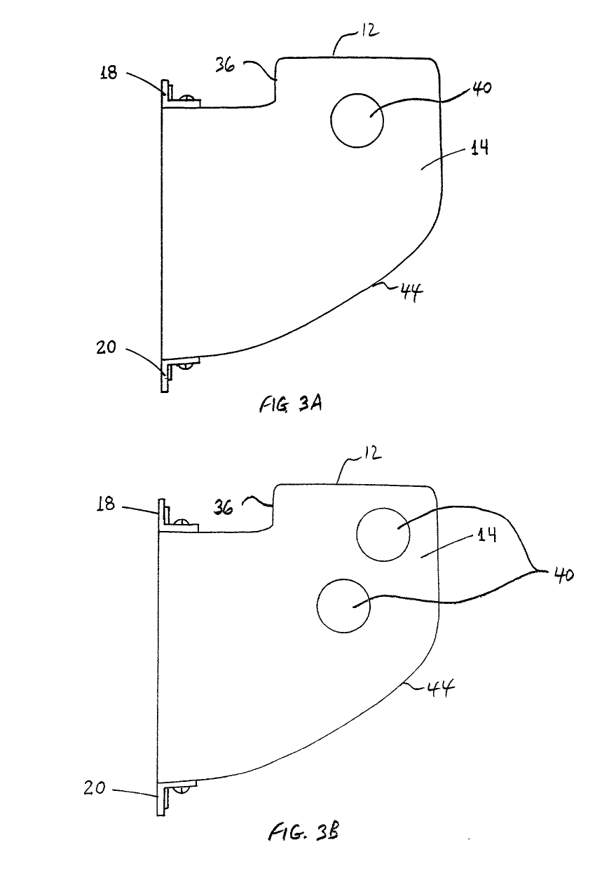

FIG. 3A illustrates a more detailed side view of a cut-in box according to another embodiment of the invention. The cut-in box has a more gradually curved sidewall 44, a top sidewall 12 with a neck 36, a sidewall 14 with an entry point 40 in which to route a cable (not shown), and edge brackets 18 and 20.

FIG. 3B illustrates a more detailed side view of a cut-in box according to another embodiment of the invention. The cut-in box has a more gradually curved sidewall 44, a top sidewall 12 with a neck 36, a sidewall 14 with two entry points 40 in which to route two cables (not shown), and edge brackets 18 and 20.

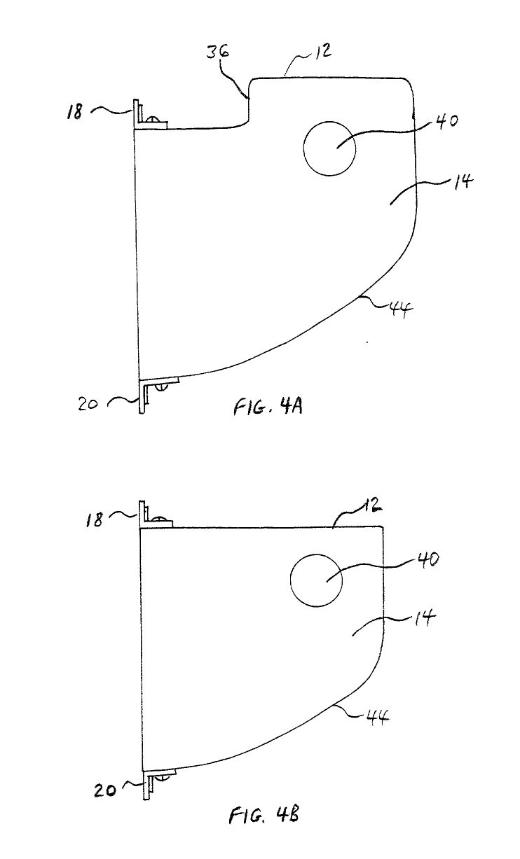

FIG. 4A illustrates a more detailed side view of a cut-in box according to another embodiment of the invention. The cut-in box has a more gradually curved sidewall 44, a top sidewall 12 with a neck 36, a sidewall 14 with an entry point 40 in which to route a cable (not shown), and edge brackets 18 and 20.

FIG. 4B illustrates a more detailed side view of a cut-in box according to another embodiment of the invention. The cut-in box has a curved sidewall 44, a flat top sidewall 12, a sidewall 14 with an entry point 40 in which to route a cable (not shown), and edge brackets 18 and 20.

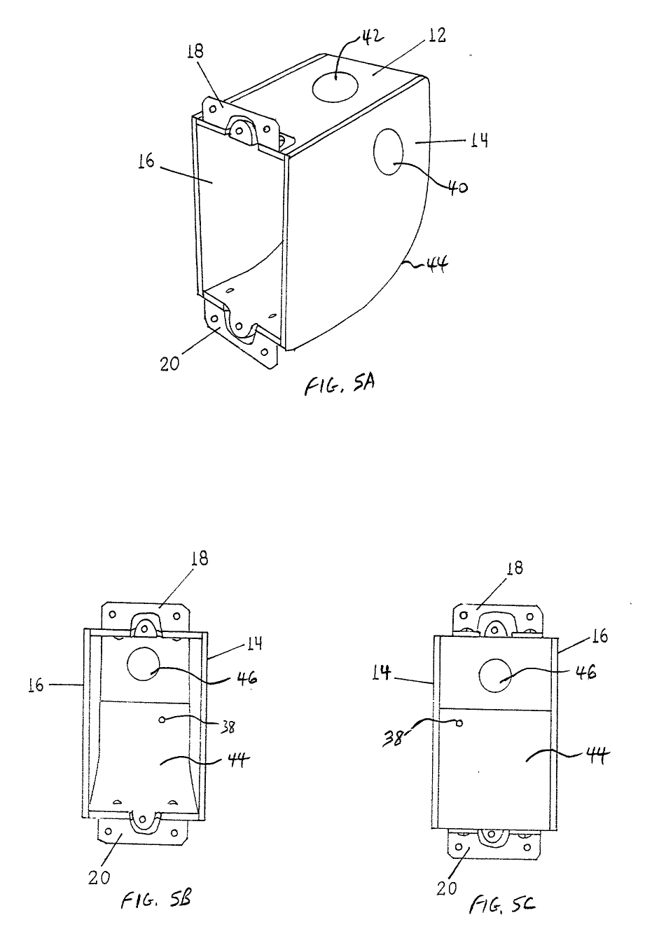

FIG. 5A illustrates a more detailed perspective view of a cut-in box shown in FIG. 4B. The cut-in box has a curved sidewall 44, a top sidewall 12 with an entry point 42 in which to route a cable (not shown), a sidewall 14 with an entry point 40 in which to route a cable (not shown), the opposite sidewall 16, and edge brackets 18 and 20. The distance between the entry point 42 and the edge bracket 18 would be greater than or equal to the thickness of the wall (not shown).

FIG. 5B illustrates a more detailed front view looking into the cut-in box shown in FIG. 5A. The cut-in box has a curved sidewall 44 with an entry point 46 in which to route a cable (not shown) and a hole 38 for a ground screw (not shown), a sidewall 14, an opposite sidewall 16, and edge brackets 18 and 20.

FIG. 5C illustrates a back view of the cut-in box shown in FIG. 5A. The cut-in box has sidewalls 14 and 16, a curved sidewall 44 with an entry point 46, and edge brackets 18 and 20. In this embodiment of the invention the curved sidewall 44 has curved surface that becomes a vertical surface.

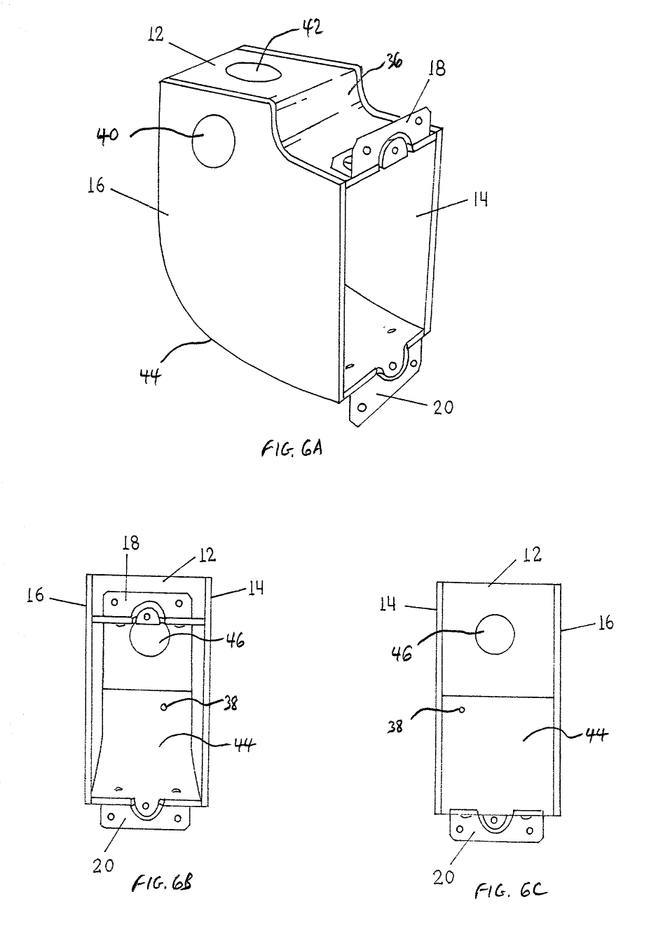

FIG. 6A illustrates a more detailed perspective view of a cut-in box shown in FIG. 4A. The cut-in box has a curved sidewall 44, a top sidewall 12 with an entry point 42 in which to route a cable (not shown) and a neck 36, a sidewall 16 with an entry point 40 in which to route a cable (not shown), the opposite sidewall 14, and edge brackets 18 and 20. The distance between the neck 36 and the edge bracket 18 would be greater than or equal to the thickness of the wall (not shown).

FIG. 6B illustrates a more detailed front view looking into the cut-in box shown in FIG. 6A. The cut-in box has a top sidewall 12, a curved sidewall 44 with an entry point 46 in which to route a cable (not shown) and a hole 38 for a ground screw (not shown), a sidewall 14, an opposite sidewall 16, and edge brackets 18 and 20.

FIG. 6C illustrates a back view of the cut-in box shown in FIG. 6A. The cut-in box has sidewalls 14 and 16, a curved sidewall 44 with an entry point 46, and edge brackets 18 and 20. In this embodiment of the invention the curved sidewall 44 has curved surface that become a vertical surface.

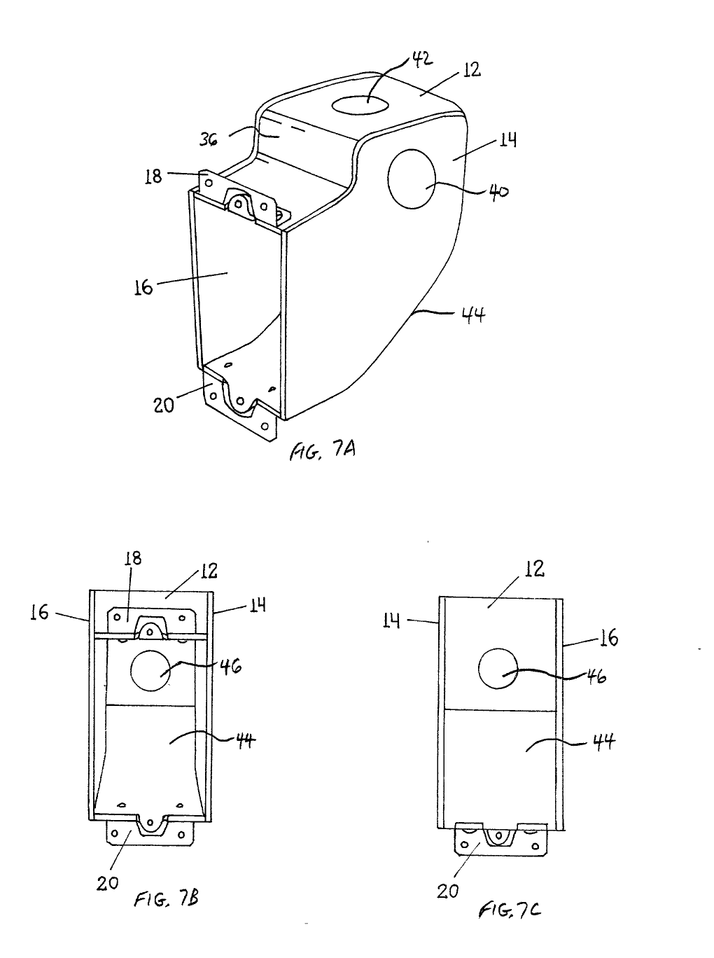

FIG. 7A illustrates a more detailed perspective view of a cut-in box according to another embodiment of the invention. The cut-in box has a more gradually curved sidewall 44, a top sidewall 12 with an entry point 42 in which to route a cable (not shown) and a neck 36, a sidewall 14 with an entry point 40 in which to route a cable (not shown), the opposite sidewall 16, and edge brackets 18 and 20. The distance between the neck 36 and the edge bracket 18 would be greater than or equal to the thickness of the wall (not shown).

FIG. 7B illustrates a more detailed front view looking into the cut-in box shown in FIG. 7A. The cut-in box has a top sidewall 12, a curved sidewall 44 with an entry point 46 in which to route a cable (not shown), a sidewall 14, an opposite sidewall 16, and edge brackets 18 and 20.

FIG. 7C illustrates a back view of the cut-in box shown in FIG. 7A. The cut-in box has sidewalls 14 and 16, a curved sidewall 44 with an entry point 46, and edge brackets 18 and 20.

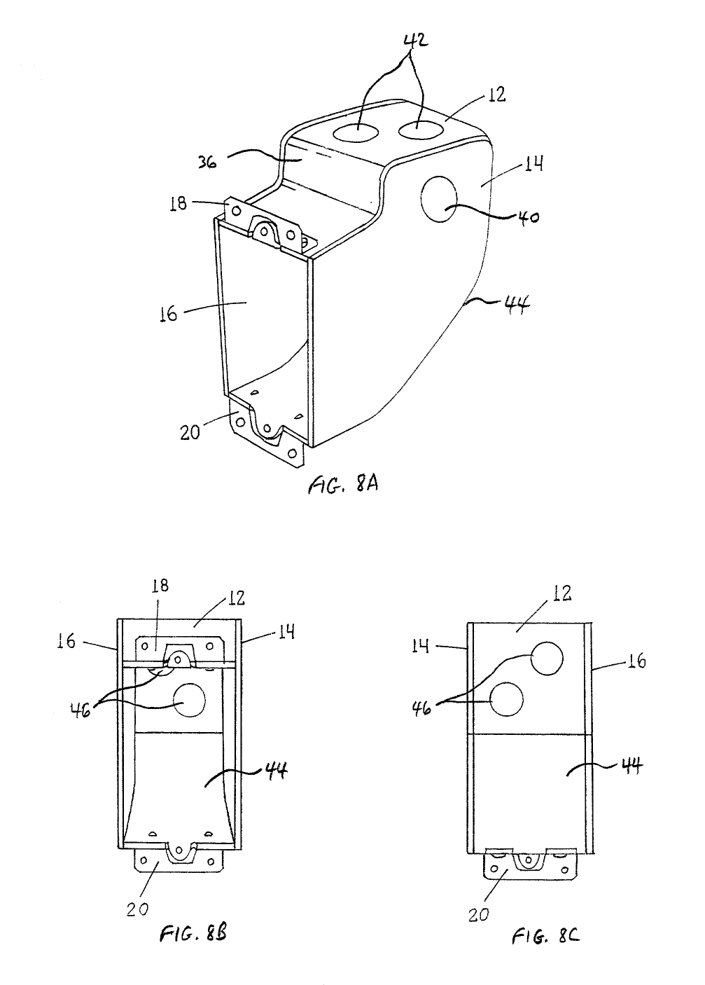

FIG. 8A illustrates a more detailed perspective view of a cut-in box according to another embodiment of the invention. The cut-in box has a more gradually curved sidewall 44, a top sidewall 12 with two entry points 42 in which to route two cables (not shown) and a neck 36, a sidewall 14 with an entry point 40 in which to route a cable (not shown), the opposite sidewall 16, and edge brackets 18 and 20. The distance between the neck 36 and the edge bracket 18 would be greater than or equal to the thickness of the wall (not shown).

FIG. 8B illustrates a more detailed front view looking into the cut-in box shown in FIG. 8A. The cut-in box has a top sidewall 12, a curved sidewall 44 with two entry points 46 in which to route two cables (not shown), a sidewall 14, an opposite sidewall 16, and edge brackets 18 and 20.

FIG. 8C illustrates a back view of the cut-in box shown in FIG. 8A. The cut-in box has sidewalls 14 and 16, a curved sidewall 44 with two entry point s 46, and edge brackets 18 and 20.

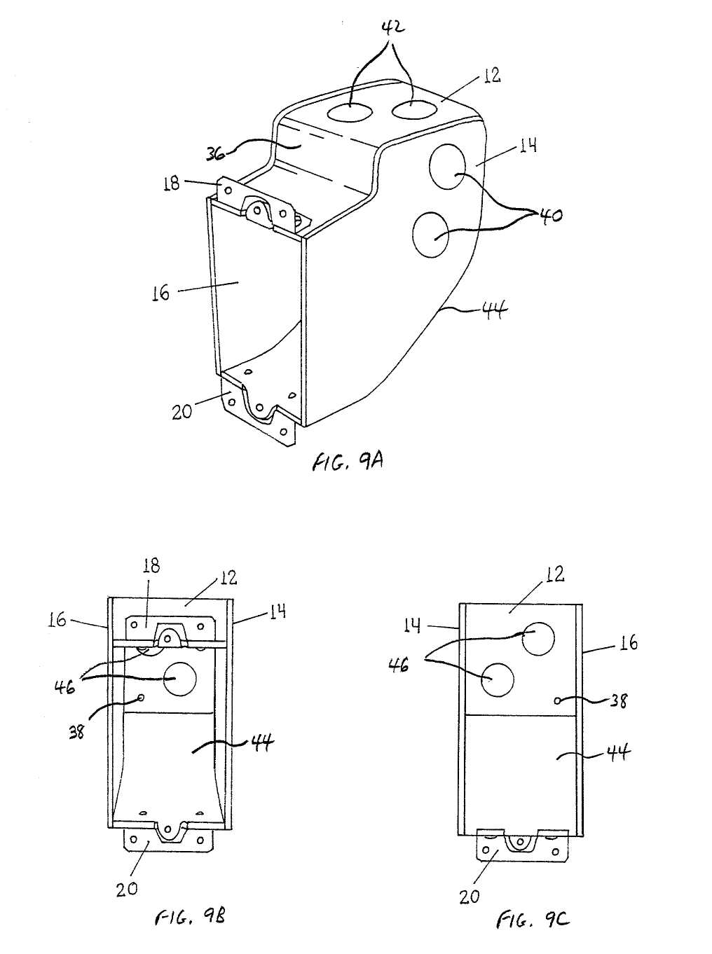

FIG. 9A illustrates a more detailed perspective view of a cut-in box according to another embodiment of the invention. The cut-in box has a more gradually curved sidewall 44, a top sidewall 12 with two an entry points 42 in which to route two cables (not shown) and a neck 36, a sidewall 14 with two an entry points 40 in which to route two cables (not shown), the opposite sidewall 16, and edge brackets 18 and 20. The distance between the neck 36 and the edge bracket 18 would be greater than or equal to the thickness of the wall (not shown).

FIG. 9B illustrates a more detailed front view looking into the cut-in box shown in FIG. 9A. The cut-in box has a top sidewall 12, a curved sidewall 44 with two entry points 46 in which to route two cables (not shown), a sidewall 14, an opposite sidewall 16, and edge brackets 18 and 20.

FIG. 9C illustrates a back view of the cut-in box shown in FIG. 9A. The cut-in box has sidewalls 14 and 16, a curved sidewall 44 with two entry points 46, and edge brackets 18 and 20.

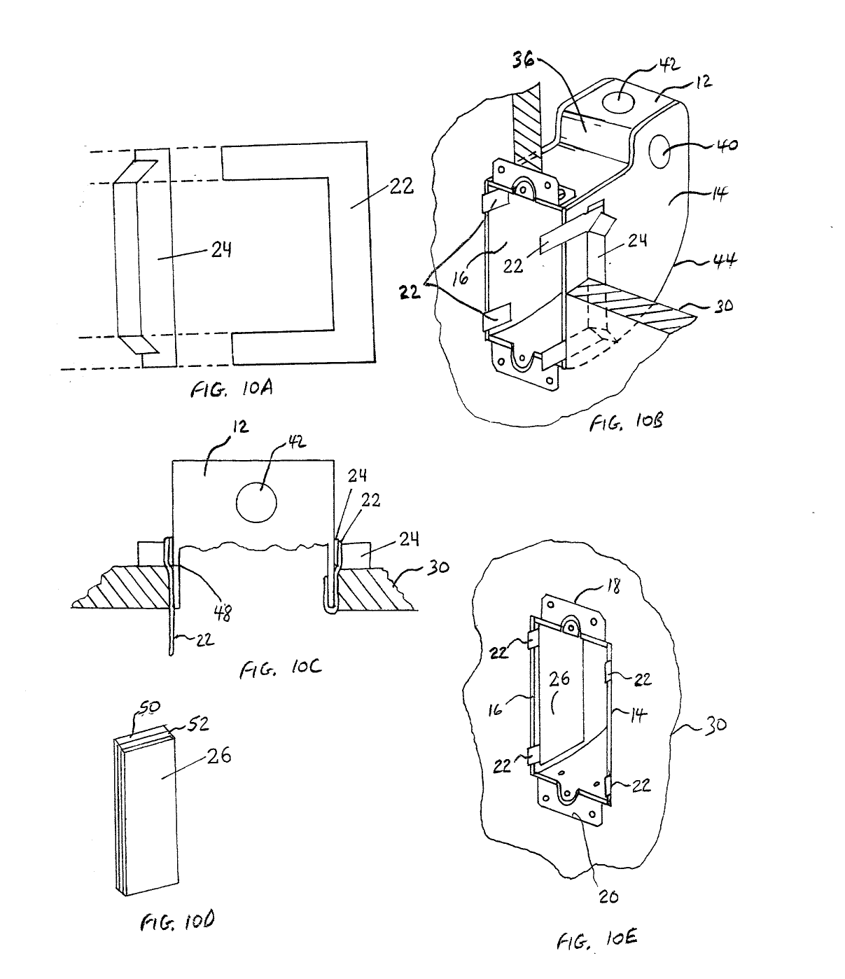

FIG. 10A illustrates a top view the two pieces of a mounting bracket according to one embodiment of the invention. A piece of flat material bent into an “L” shape 24 is cut to slide into the transverse member of the “U” shaped piece 22 with two arms. One arm of the “L” shape 24 is parallel to the plane of the “U” shaped piece 22, while the other arm of the “L” shape 24 is perpendicular to the plane of the “U” shaped piece 22.

FIG. 10B illustrates a more detailed perspective view of a cut-in box according to another embodiment of the invention as it is installed in a wall 30. The cut-in box 10 has a more gradually curved sidewall 44, a top sidewall 12 with an entry point 42 in which to route a cable (not shown) and a neck 36, a sidewall 14 with an entry point 40 in which to route a cable (not shown), the opposite sidewall 16, and edge brackets 18 and 20. The arms of one “U” shaped piece 22 are shown unbent, with one leg of the “L” shape 24 pressed up to the back of the wall 30 by the transverse member of the “U” shaped piece 22. The second leg of the “L” shape 24 is substantially planar and presses up against the sidewall 14 in this embodiment of the invention, but alternative embodiments of the invention may incorporate “L” shapes 24 with non-planar legs. The arms of a second “U” shaped piece 22 are shown bent over the exposed edge of sidewall 16 of the cut-in box. The arms of the “U” shaped piece 22 are normally substantially orthogonal or perpendicular to the transverse member of the “U” shaped piece 22, but the arms can be non-parallel to each other and can be non-orthogonal to the transverse member in alternative embodiments of the invention. The transverse member of the “U” shaped piece 22 can also be non-linear and non-planar in alternative embodiments of the invention.

FIG. 10C illustrates a more detailed top view of the cut-in box shown in FIG. 10B, including a top sidewall 12 with an entry point 42, the bent arm of one “U” shaped piece 22, with the “L” shape 24 pressed up to the back of the wall 30. The arm of a second “U” shaped piece 22 is shown unbent to illustrate a curve 48 in the “U” shaped piece 22 for one embodiment of the invention that is more easily inserted through the wall opening.

FIG. 10D illustrates a perspective view of an anti-short mechanism, according to one embodiment of the invention. An electrically insulating material 26 is detachable from a substrate 50, and can be held by adhesive layer (e.g., a silicone compound, an epoxy, a thermal epoxy, a resin, or a glue) 52. The electrically insulating material 26 (e.g., a plastic, a thermo-setting plastic, a rubber, or a glass fiber composite) can preferably become rigid if it is heated to a pre-selected temperature (e.g., if it includes a thermo-setting plastic).

FIG. 10E illustrates a more detailed perspective view of a cut-in box according to another embodiment of the invention as it is installed in a wall 30. The cut-in box has a sidewall 16 with the electrically insulating material 26 attached over the inside surface of the sidewall 16, and edge brackets 18 and 20. The arms of two “U” shaped pieces 22 are shown bent over the exposed edges of sidewall 16 and sidewall 14 of the cut-in box. The electrically insulating material 26 is shown covering the arms of one “U” shaped piece 22 bent over the exposed edge of sidewall 16, and thereby prevents an electrical short between the arms bent over the exposed edge of sidewall 16 and the wiring connections (not shown) inside the cut-in box. The electrically insulating material 26 is preferably large enough to cover both bent arms, but should at least cover a portion of one bent arm projecting inside a cut-in box.

Embodiments of the cut-in box can be made from several materials (e.g., a sheet metal, a galvanized sheet metal, metal alloys, a thermo-plastic, a thermo-setting plastic, a rubber, or a ceramic). The cut-in box or the mounting bracket pieces 22 and 24 can be formed by molding, stamping, or machining. Embodiments of the mounting bracket pieces 22 and 24 can be fabricated from sheet metal, galvanized sheet metal, or a molded, stamped, or machined piece of metal alloy or plastic. The invention can be used with any wallboard (e.g., gypsum board, drywall, plywood, wood composite, or an equivalent).

The exemplary embodiments described herein are for purposes of illustration and are not intended to be limiting. Therefore, those skilled in the art will recognize that other embodiments could be practiced without departing from the scope and spirit of the claims set forth below.

What is claimed is:

1. An improved cut-in box to facilitate connection to at least one cable behind a wallboard, comprising:
an enclosure with multiple sidewalls, having at least one sidewall curved in the depth dimension to facilitate insertion of said enclosure through a wallboard having a wall opening, wherein said enclosure has at least one sidewall with one or more entry points for connection to at least one cable behind said wallboard and said wall opening.

2. The improved cut-in box of claim 1, wherein said cut-in box is an electrical cut-in box.

3. The improved cut-in box of claim 1, wherein said cut-in box is an optical fiber cut-in box.

4. The improved cut-in box of claim 1, wherein said cut-in box has a neck on at least one sidewall of said enclosure.

5. The improved cut-in box of claim 1, wherein said cut-in box has a neck on at least one sidewall of said enclosure, and said at least one sidewall has one or more entry points available to said at least one cable behind said wallboard and said wall opening.

6. The improved cut-in box of claim 1, wherein said cut-in box is composed of a material chosen from materials consisting of: sheet metal, galvanized sheet metal, metal alloy, thermoplastic, thermo-setting plastic, rubber, or ceramic.

7. The improved cut-in box of claim 1, wherein said improved cut-in box is supported in said wall opening by at least one edge bracket.

8. The improved cut-in box of claim 1, wherein said improved cut-in box is supported in said wall opening by at least one mounting bracket comprising:
a first piece of material having a transverse member, and a first arm and a second arm attached to a length of said transverse member, having a substantially orthogonal intersections between said transverse member and said first arm and said second arm, wherein said first arm and said second arm extend from said transverse member to reach through said wall opening;
a piece of substantially flat material bent in the form of an “L” shape having a first leg and a second leg, having a width across said first leg and said second leg, wherein said width of said first leg of said “L” shape is substantially equal to said length of said transverse member of said first piece of material, and said first leg of said “L” shape is designed to substantially conform to said wallboard surrounding said wall opening.

9. A cut-in box mounting bracket to substantially clamp a cut-in box to a wall opening in a wallboard, comprising:
a “U” shaped piece of material having a transverse member with a length having a first end and a second end, wherein a first arm is formed at said first end and a second arm is formed at said second end; and
a piece of material formed in an “L” shape having a first leg and a second leg, and a width across said first leg and said second leg, wherein said width of said first leg of said “L” shape is substantially equal to said length of said transverse member of said “U” shaped piece of material, and said first leg of said “L” shape is designed to substantially conform to said wallboard in proximity to said wall opening.

10. The cut-in box mounting bracket of claim 9, wherein said second leg of said piece of material formed in an “L” shape substantially conforms to a sidewall of said cut-in box.

11. The cut-in box mounting bracket of claim 9, wherein said cut-in box is an electrical cut-in box.

12. The cut-in box mounting bracket of claim 9, wherein said cut-in box is an optical fiber cut-in box.

13. The cut-in box mounting bracket of claim 9, wherein said “U” shaped piece of material has a substantially perpendicular attachment between said transverse member and said first arm, and a substantially perpendicular attachment between said transverse member and said second arm.

14. The cut-in box mounting bracket of claim 9, wherein said piece of material formed in an “L” shape is comprised of a material consisting of: sheet metal, galvanized sheet metal, metal alloy, thermoplastic, thermo-setting plastic, rubber, or ceramic.

15. The cut-in box mounting bracket of claim 9, wherein said “U” shaped piece of material is comprised of a material consisting of: sheet metal, galvanized sheet metal, metal alloy, thermoplastic, or thermo-setting plastic.

16. The cut-in box mounting bracket of claim 9, wherein said arms of said “U” shaped piece of material can be bent to fold across an edge of a cut-in box.

17. An anti-short mechanism attachable to a sidewall of an electrical cut-in box, comprising:
an electrically insulating material having a substantially flat plane with a insulating first side and a second side;
an adhesive layer deposited on said second side of said electrically insulating material; and
a detachable substrate attached to said adhesive layer, wherein said electrical insulating material and said adhesive layer are easily removed from said substrate and easily attached to a sidewall of said electrical cut-in box.

18. The anti-short mechanism of claim 17, wherein said electrically insulating material comprises a material consisting of: a thermo-plastic, a thermo-setting plastic, a rubber, or a glass fiber composite.

19. The anti-short mechanism of claim 17, wherein said electrically insulating material is comprised of a material that becomes rigid after said electrically insulating material is heated to a pre-selected temperature.

20. The anti-short mechanism of claim 17, wherein said adhesive layer comprises a material consisting of: a silicone compound, an epoxy, a thermal epoxy, a resin, or a glue.
